(19) United States
(12) Patent Application Publication
(10) Pub. No.: US 2021/0094033 A1
(43) Pub. Date: Apr. 1, 2021

(54) A MICROFLUIDIC DETECTION DEVICE WITH IMMOBILIZED BIOCHEMICAL ASSAYS, FABRICATION OF SAME AND METHOD OF ANALYSING A FLUID SAMPLE

(71) Applicant: NORDETECT IVS, Copenhagen (DK)

(72) Inventors: Keenan Pinto, Copenhagen (DK); Palak Sehgal, (US)

(21) Appl. No.: 17/050,276

(22) PCT Filed: Apr. 26, 2019
(86) PCT No.: PCT/EP2019/060823

§ 371 Date: Oct. 23, 2020

(30) Foreign Application Priority Data
Apr. 26, 2018 (EP) 18169533.9

(51) Int. Cl. B01L 3/00

(52) U.S. Cl. CPC B01L 3/502707; B01L 2200/10; B01L 3/502746; B01L 3/54; B01L 2300/16; B01L 2400/086; B01L 2400/0694; B01L 2300/08; B01L 2300/0887; B01L 2200/12; B01L 2300/123; B01L 2300/0816; B01L 2300/0819; B01L 2300/0874; B01L 2300/0883; B01L 2300/021; B01L 2300/0636; B01L 2200/16; B01L 2400/0406; B01L 2300/048; B01L 3/50273

(57) ABSTRACT

The invention relates to a microfluidic chip with specifically shaped chambers to improve operability. The present invention further relates to a method of manufacturing a microfluidic chip, which has reagents embedded inside and which can perform analysis of multiple target analytes from a single test sample. Further, the invention relates to a simple analysis system that can be used by non-technical users by automating several stages of the process and providing the end user with simple feedback.

### FIELD OF THE INVENTION

The present invention relates to capillary-flow power-free, disposable microfluidic detection devices, also known as microfluidic chips, and methods for fabricating the same.

The present invention further relates to chemical/biochemical analyte detection using a microfluidic chip.

The present invention also relates to methods for immobilizing stable dried chemistries within a microfluidic chip.

### BACKGROUND OF THE INVENTION

Portable biochemical analysis devices may detect particular compounds from a provided sample. Such analysis is usually carried out to investigate a particular compound of interest such as e.g. detection of diseases like malaria, HPV, STDs, etc. or deficiencies like micronutrients and hormones all of which examples are done by analysis of blood samples.

Microfluidic chips, also called micro-reactors, are based on technology that enables precise and automated manipulation of nanoliters or picoliters of fluid in a miniaturized, integrated and high-throughput device. The microfluidic chip can provide thorough mixing, low sample consumption, implementation of assays based on e.g. biology, chemistry, nanotechnology, physics and automation. It is also known as lab-on-a-chip technology or micro-Total-Analysis-Systems (microTAS). In such systems, waste and exposure to chemicals is minimized as compared to established traditional laboratory systems. A microfluidic chip comprises reagents, which are mostly irreversibly changed when activated by analytes and are therefore often for one time use.

Present microfluidic chips are very elaborate and complex in their functioning. The fabrication of each device is highly intricate with use of micro-pumps and micro-electronic components for driving the fluid sample and reaction chemistries are usually loaded as liquids in the reaction and/or detection chambers, included in the microchip. The design and fabrication of a single device sometimes takes a long time with the integration of microelectronic components, which increases the overall cost of manufacturing in bulk. Therefore, scale of production is difficult to attain. To the best of the inventors' knowledge, there is at present no commercially available microfluidic devices for testing and analyses of more than one analyte at a time. The commercial systems that do exist are confined to research sites and require skilled technicians to handle and operate. All of these disadvantages have hindered the entry of microfluidics technology into common use.

Hence, an improved chip for multi-analyte testing using microfluidic technology would be advantageous and in particular a simpler and more efficient method of manufacturing functional microfluidic chips with embedded reagents would be advantageous. An analysis system that could be used by non-technical users would enhance the adoption of this technology and help spur new developments and use-cases.

### OBJECT OF THE INVENTION

It is an object of the present invention to provide a method of manufacturing a microfluidic chip, which has reagents embedded inside and which can perform analysis of multiple target analytes from a single test sample.

It is another object of at least some embodiments of the present invention to provide a simple analysis system that can be used by non-technical users by automating several stages of the process and providing the end user with simple feedback.

It is another object of the present invention to provide a microfluidic chip that allows analysis of multiple components of a single sample in a time-effective process.

It is a further object of the present invention to provide an alternative to the prior art.

In particular, it may be seen as an object of the present invention to provide a microfluidic chip, a microfluidic analysis system and a method of fabrication of a microfluidic chip that solves the above mentioned problems of the prior art.

### SUMMARY OF THE INVENTION

Thus, the above described object and several other objects are intended to be obtained in a first aspect of the invention

In a first aspect, the invention relates to a microfluidic chip comprising:
an inlet;
at least one fluid path comprising at least one fluidic channel from the inlet to an outlet, said at least one fluidic path comprising a detection chamber and optionally a reaction chamber between the inlet and the detection chamber;
said at least one fluidic path being enclosed and configured to allow a fluid sample dispensed onto the inlet to move through fluidic channels to the detection chamber surface due to capillary motion,
characterised in that
the outlet contains a vent to enable capillarity, said outlet being adjacent to the detection chamber and positioned substantially opposite to where the fluidic channel enters the detection chamber.

Positioning the outlet substantially opposite to where the fluidic channel enters the detection chamber ensures that the capillary flow of the fluid sample through the detection chamber is even. The fluid sample is able to wick effectively and coat the entire surface of the detection chamber.

The detection chamber surface is typically aligned with an inspection window that allows electromagnetic radiation emitted from the detection chamber surface to leave the microfluidic chip. This allows analysis of the fluid sample once it has come into contact with the detection chamber surface.

Desirably, the outlet and particularly the vent does not overlap with the inspection window of the detection chamber.

Typically, the detection chamber surface will contain a reagent that interacts with the fluid sample, which interaction can be monitored using electromagnetic radiation. More accurate analysis will be possible when the capillary flow of the fluid sample into and through the detection chamber provides an even coating on the detection chamber surface. The driving force of the capillary flow is movement of the fluid sample to the vent in the outlet. Positioning the outlet substantially opposite to where the fluidic channel enters the detection chamber ensures the capillary flow coats the detection chamber surface evenly.

The vent in the outlet is typically positioned substantially opposite to where the fluidic channel enters the detection chamber. This is however not essential, and for constructional reasons it may be desirable to locate the vent at the end of a channel leading from the detection chamber. This may be the case if the microfluidic chip is to be used in an analysis device, and the structure of the analysis device prevents the location of the vent in close proximity to the detection chamber surface/inspection window.

By “substantially opposite” is meant that the angle formed by the centre point where the detection chamber meets the fluidic channel (i.e. the transitional zone between the fluid channel and the detection chamber), the centre point of the entrance to the outlet (i.e. the transitional zone between the detection chamber and any channel to the vent), and the centre point of the detection chamber (hereinafter the “outlet angle”), is from 150° to 180°. Desirably, the outlet angle is from 160° to 180°, more desirably from 170° to 180°.

All three points which define this angle are defined as points in an idealised plane formed by the detection chamber surface (i.e. the surface as viewed from above such as through any inspection window). It is thus recognised that an enclosed fluidic path may not have constant dimensions, and particularly may not have constant depth. For instance, the detection chamber surface may contain features such as ridges, or the detection chamber itself may have a non-constant depth such as when the detection chamber is ovoid in shape.

The centre points used to define the outlet angle represent the centre points of the fluidic path at three specific points, these points lying in a plane (or, in the case where the angle is 180°, in a line) which is positioned above the detection chamber surface and running substantially parallel to that surface.

The detection chamber is typically wider than the fluidic channel. The width of the detection chamber corresponds to the direction of the detection chamber surface which is orthogonal to the direction of idealised capillary flow. In other words, the width of the detection chamber is the dimension orthogonal to the idealised flow direction when the detection chamber surface is viewed from above (i.e. through any inspection window).

By “idealised capillary flow” is meant the flow direction in an idealised system, not accounting for any wicking effects that may occur. This is typically congruent with the centreline of the fluidic path.

The fluidic path desirably contains fillets between any sections where the cross-sectional area (i.e. the profile of the fluidic path orthogonal to the flow direction) changes. In other words, the fluidic path is desirably filleted.

In particular, the transitional zone between the fluidic channel and detection chamber is desirably filleted. Typically, the transitional zone between the detection chamber and outlet is also filleted.

By “fillet” or “filleted” in this context is meant a rounding of the corners along the fluidic path when it is changing from one cross-sectional area to another. The rate of change of the width and/or height of the fluidic path therefore does not undergo any discontinuities along the transitional zone between the various portions of the fluidic path (e.g. between the fluidic channel and detection chamber).

By using fillets to change the cross-sectional dimensions of the fluidic path, the wicking of the fluid sample during capillary flow can be more easily controlled.

Typical dimensions for the fillets connecting the fluidic channel to the detection chamber, and the detection chamber to the outlet, are a curve with a radius of from 1 to 10 mm, desirably from 2 to 8 mm, more desirably from 3 to 7 mm, e.g. from 4 to 6 mm or about 5 mm.

The rate of change of the width of the detection chamber likewise typically does not contain any discontinuities along its length. This ensures that the fluid sample wicks evenly as it flows through the detection chamber.

Desirably, the rate of change of the width of the fluidic path does not undergo any substantial discontinuities along substantially the entire length of the fluidic path. By “substantial discontinuities” is meant the change in width/height is abrupt, such that the fluid sample is not able to wick effectively by capillary flow.

Desirably, the filleting on either side of the entrance to the detection chamber is substantially identical. In other words, the curvature and extent of any rounding on one side of the mid-point of the transition zone between the fluidic channel and the inspection chamber is substantially identical to the curvature of any rounding on the other side of the mid-point.

Identical fillets are mirror images, with the mirror line being the mid-point of the transitional zone. Substantially identical fillets will have a level of symmetry such that a fluid will wick along the respective fillets at the same rate. In this context, substantially identical fillets may not be exact mirror images, but they functionally control the flow of the fluid sample to ensure that it wicks along the respective fillets and enters the detection chamber at the same time.

As the outlet is positioned substantially opposite to where the fluidic channel enters the detection chamber, the profile of the detection chamber is substantially symmetrical about the plane formed from the centre point where the detection chamber meets the fluidic channel (i.e. the transitional zone between the fluid channel and the detection chamber), the centre point of the entrance to the outlet (i.e. the transitional zone between the detection chamber and any channel to the vent), and which is oriented in the depth direction of the detection chamber (i.e. orthogonal to the detection chamber surface).

By “substantially symmetrical” in this context is meant that the profile of one side of the detection chamber essentially mirrors the profile of the other side of the detection chamber, the mirror plane running through the line formed by the centre point where the fluidic channel connects to the detection chamber, and the centre point where the detection chamber connects to the outlet.

A detection chamber having a substantially symmetrical profile will have a wicking time (i.e. the time taken for the fluid sample to move by capillary flow) along the interface between the detection chamber surface and one side of the detection chamber which is substantially identical to the wicking time along the interface between the detection chamber surface and the other side of the detection chamber.

In this context, the “side” of the detection chamber is the profile of the detection chamber surface as viewed from above, e.g. through the inspection window.

The fluidic channel typically has a relatively small cross-sectional area, by the cross-sectional area can change significantly at the detection chamber.

Typical dimensions of the fluidic channel are a depth of between 75 and 175 μm, e.g. between 100 and 150 μm or between 115 and 135 μm.

The typical width of the fluidic channel is from 100 to 500 μm, such as from 200 to 400 μm or from 250 to 350 μm.

The depth of the detection chamber is typically at least 500 μm. The detection chamber is therefore typically deeper than the fluidic path. This arrangement allows the fluid sample to collect in the detection chamber in sufficient volumes to react with the detection reagents that are present.

It has been found that capillary flow is not affected by a step change in depth between the fluidic channel and detection chamber, particularly if the wicking is suitably controlled by the gradual change in width of the chamber and presence of fillets in the transitional zone between the fluidic channel and the detection chamber.

The detection chamber is typically no more than 1500 μm deep, thus typically the depth of the detection chamber is from 500 to 1500 μm, more typically from 500 to 1200 μm, such as from 800 to 1000 μm.

The microfluidic chip may be formed from a plurality of layers. For instance, the microfluidic chip may comprise:
a base layer;
a fluidic channel layer; and
a capping layer.

The role and functional purpose of these layers are described in more detail in relation to the second aspect of the invention, which is a method of fabricating a microfluidic chip comprising at least one fluid path from an inlet through at least one fluidic channel and to an outlet, the method comprising:
providing a plurality of layers, which are initially separated, each of the layers in the plurality of layers being made of at least one polymeric material, each of the plurality of layers being substantially shaped as a rectangular cuboid having two opposite surfaces, which are significantly larger than other surfaces of the layer, wherein at least one layer of the plurality of layers typically comprises an adhesive on both of its larger surfaces, ensuring that enough layers comprise an adhesive such that when the plurality of layers are assembled at a later time at least one of any two larger surfaces facing each other comprises an adhesive,
providing the inlet in one of the plurality of layers,
providing at least one outlet in a larger surface of one of the plurality of layers,
providing at least one layer of the plurality of layers with one or more fluidic channels, where providing a layer with fluidic channels comprises at least one of:
   engraving a channel structure onto one or both of the larger surfaces of the layer, and/or
   cutting a channel structure by cutting throughgoing channels in the larger surfaces of the layer, and/or
   cutting a fluidic passage hole by cutting a throughgoing hole in the larger surfaces of the layer thus creating a fluidic channel that allows fluid to flow from one layer to another,
optionally, creating at least one reaction chamber surface (8) by at least one of:
   engraving on a larger surface of at least one layer of the plurality of layers (3, 4, 5) to make an indentation and/or a pattern, and/or
   cutting a fluidic passage hole in a larger surface of at least one layer of the plurality of layers, whereby the fluidic passage hole cut-out will define a reaction chamber surface on an adjacent layer after assembly of the plurality of layers,
creating at least one detection chamber surface (9) by at least one of:
   engraving on a larger surface of at least one layer of the plurality of layers (3, 4, 5) to make an indentation and/or a pattern, and/or
   cutting a fluidic passage hole in a larger surface of at least one layer of the plurality of layers, whereby the fluidic passage hole cut-out will define a detection chamber surface on an adjacent layer after assembly of the plurality of layers,
preparing at least one of the reaction chamber surfaces, if present, and/or at least one of the detection chamber surfaces, wherein preparing a reaction chamber surface and/or a detection chamber surface comprises:
   dispensing at least one reagent onto the reaction chamber surface and/or detection chamber surface,
   subsequently, if required to immobilize the dispensed reagent, drying and/or ventilating the reaction chamber surface and/or detection chamber surface,
assembling the plurality of layers, where assembling the plurality of layers comprises stacking the layers in the plurality of layers on top of each other with a larger surface of one layer aligning with a larger surface of another layer, such that:
   the inlet is not covered,
   at least one of any two larger surfaces facing each other comprises an adhesive,
   at least one inspection window aligns with a detection chamber surface, the inspection window allowing electromagnetic radiation emitted from the detection chamber surface to leave the microfluidic chip,
   the at least one fluid path is provided by aligning the inlet, fluidic channel(s), reaction chamber surface(s) (if present), detection chamber surface(s) and outlet(s) such that the at least one fluid path further extends to one of the at least one detection chamber surfaces,
   the at least one fluid path will allow a fluid sample dispensed onto the inlet to move through fluidic channels to at least one detection chamber surface due to capillary motion, and
bonding the plurality of layers together.

In some embodiments, at least one inspection window is the outlet.

In some embodiments (such as embodiments to produce a microfluidic chip according to the first aspect of the invention), the outlet contains a vent to enable capillarity, and said outlet is adjacent to the detection chamber and positioned substantially opposite to where the fluidic channel enters the detection chamber.

By the layers being initially separated is meant that each of the layers is initially unattached to any other layer.

By engraving a channel structure onto a larger surface of a layer is meant that contiguous indentations are made in the surface.

The layers in the plurality of layers may have larger surfaces having the same or close to the same dimensions.

When a microfluidic chip is fabricated, the at least one detection chamber surface will form part of a detection chamber, the detection chamber being formed when a detection chamber surface is partly enclosed by one or more adjacent layers, while still allowing for fluid to enter and exit the detection chamber.

Likewise, when a microfluidic chip is fabricated, any reaction chamber surface will form part of a reaction chamber, the reaction chamber being formed when a reaction chamber surface is partly enclosed by one or more adjacent layers, while still allowing for fluid to enter and exit the reaction chamber.

Engraving on a larger surface of at least one of the plurality of layers to create at least one reaction chamber surface and/or at least one detection chamber surface, may be done using a micro-pulsed laser. The engraving may be done in circular or elliptical shapes.

When engraving to create at least one reaction chamber surface and/or at least one detection chamber surface, the depth of the engraving determines the volume of fluid that can be loaded into the engraved portion.

The depth of the engraved portion together with the thickness of the fluidic channel layer together make the depth of the detection chamber, which is as set out above.

When dispensing at least on reagent onto the reaction chamber surface and/or detection chamber surface, the dispensing may be done by hand or a dispensing machine may be used to dispense minute amounts of reagent. The reagent may be integrated with a surfactant to increase wettability/spreadability on the surface. The method of preparing at least one of the reaction chamber surfaces, if present, and/or at least one of the detection chamber surfaces may be as follows:
for physical adsorption, at least one liquid reagent may be dispensed on to the chamber surface. The layer comprising the chamber surface may then be placed in a dry-box (low humidity and room temperature condition to evaporate any water and leave behind the desired molecules onto the chamber surface.
for polymer membrane coating (PVC, PVP, etc.), where the functional molecules are uniformly distributed in the polymer, the polymer mixture is drop coated onto the chamber surface using the dispensing machine following which air-suction is applied via a ventilation system that removes the solvent and deposits the polymer membrane on the chamber surface.
for hydrogel/polymer mixtures and typically where proteins and biomolecules are used, the hydrogel is first used to coat the chamber surface to create a suitable environment, following which the proteins are dispensed and air dried, and then another layer of hydrogel may be applied to seal the biomolecules inside the chamber.

The engraved well that forms the reaction/detection chamber acts as a reservoir that holds the reagent as it is coated on the surface, localising the reagent within the chamber.

In further embodiments, the at least one layer comprising reagents is prepared beforehand and then used in the fabrication of a microfluidic chip at a later time point. This also has the benefit in the manufacturing process that it allows for all reagents to be coated prior to final assembly.

After fabrication of the microfluidic chip at least one fluid path extends from the inlet, through at least one fluidic channel, optionally through at least one reaction chamber, into a detection chamber to end at an outlet. The structures comprising the fluid path: inlet, outlet, chambers and fluidic channels, are dimensioned such that the fluid sample dispensed at the inlet moves through the fluid path due to capillary motion.

In an embodiment, at least one of the detection chambers comprises a photonic crystal having an optical grating with a pitch in the interval 100-1000 nm. A photonic crystal may provide a higher limit of detection in fluorescence image analysis. It can be manipulated to provide tight optical confinement as sharp wavelengths at resonant frequency. A fluorescent chemical compound that can re-emit light upon light excitation, also called a fluorophore, in a fluid sample will provide a strong enhanced fluorescence emission when in contact with such a grating structure in a detection chamber.

In some embodiments, the plurality of layers comprises three or four layers.

In an embodiment, one or more of the layers in the plurality of layers is made of a material that makes it easier for a user to handle the fabricated microfluidic chip.

In further embodiments, bonding is done by heating of the assembled plurality of layers. Heating may be done using a lamination device.

In some embodiments of the invention, the method further comprises providing an identifier to the microfluidic chip, where the identifier is detectable by visual inspection or other types of inspection. The identifier may be an engraving in a layer, where the engraving is done before, during or after fabrication of a microfluidic chip. The identifier may be a pattern such as dots arranged in an abstract shape.

In some embodiments of the invention, the adhesive is an acrylic adhesive.

In further embodiments of the invention, the adhesive is an adhesive liner. By this is meant that the adhesive has a liner on top of it that maintains its integrity while it is processed, e.g. by a laser. Such a liner is peeled off to reveal the adhesive prior to assembling with other layers. This provides air tight sealing of layers and is part of a process to create fluidic channels in a chip.

In some embodiments of the invention, the at least one layer comprising one or more fluidic channels is made of at least one of: polyethylene terephthalate (PET), poly(methyl methacrylate) (PMMA) and/or Cyclic Olefin Copolymer (COC/COP).

In further embodiments of the invention, the at least one layer comprising one or more fluidic channels is made of a composite material. The composite material may provide rigidity and increased integrity of the fluidic channel(s), while comprising an adhesive on one or both of the larger surfaces of the layer. The composite material may comprise PET and an adhesive.

In an embodiment of the invention, the at least one layer comprising one or more fluidic channels is made of a composite material having a sandwich structure. The sandwich structure may comprise PET or PMMA in the middle sandwiched by an acrylic adhesive on both sides.

In another embodiment of the invention, the at least one layer comprising one or more fluidic channels has a thickness of between 75 and 175 micrometres. The thickness of the at least one layer comprising one or more fluidic channels may be between 100 and 150 micrometres or between 115 and 135 micrometres.

In some embodiments of the invention, each of the layers in the plurality of layers provided are made of at least one of: a thermosetting polymer and/or a thermoplastic polymer and/or an elastomer and/or a glass and/or quartz.

In further embodiments of the invention, each of the layers in the plurality of layers provided are made of at least one polymeric material selected from: PDMS, PVA, PMMA, PVC, glass, SU-8, silicon nitride, silicon, quartz and the composite and crosslinked mixture of two or more materials. The polymers may be modified with adhesives, surface modifying chemicals or stabilizers either during or post production of a layer.

In some embodiments of the invention, a layer comprising at least one reaction chamber surface and/or at least one detection chamber surface is made of a different polymeric material than a layer comprising one or more fluidic channels.

In further embodiments of the invention, a layer comprising at least one reaction chamber surface and/or at least one detection chamber surface is made of PMMA.

In another embodiment of the invention, a layer comprising at least one reaction chamber surface and/or at least one detection chamber surface has a thickness of 1.0-2.0 mm. A layer comprising at least one reaction chamber surface and/or at least one detection chamber surface may have a thickness of 1.3-1.7 mm.

Each layer of the plurality of layers may be made of similar materials or different materials such as PMMA, polycarbonate (PC), polyimide (PI), polyethylene terephthalate (PET), Cyclic Olefin Copolymer (COC), Cyclic Olefin polymer (COP), and/or polyvinylpyrrolidone(PVP).

Each layer of the plurality of layers may have the same, similar or different thickness and/or colour(s).

In some embodiments of the invention, at least one of the patterns engraved to provide a reaction chamber surface and/or a detection chamber surface increases the binding affinity for a reagent to be dispensed thereupon.

In another embodiment, at least one reaction chamber surface and/or at least one detection chamber surface is pre-treated with a polymer coating, such as sol-gel or PVP, to increase the binding affinity for a reagent to be dispensed thereupon

In further embodiments, at least one reaction chamber surface and/or at least one detection chamber surface is cleaned with one or more solvents and/or compressed air to remove any chemical impurities that may interact with the physical adsorption of chemistries that will physically adsorb onto it later in the fabrication process. Thus, the cleaning takes place before the at least one reagent is dispensed.

In some embodiments of the invention, the inlet is cut or engraved in a droplet shape, trapezoidal shape, triangular shape or any other tapering geometrical shape. An inlet having a geometrical shape with a thinner end connecting to the fluidic channels provides a smaller surface area connecting to the channels, which facilitates the capillary action.

In a further embodiment, the inlet can accommodate a fluid sample having a volume of between 5 nanoliters and 100 microliters.

In another embodiment, the inlet and/or outlet(s) is modified with pieces of acrylic to allow for tubes or adapters to be connected to the inlet and/or outlet.

In some embodiments of the invention, the at least one reagent dispensed onto a reaction chamber surface and/or a detection chamber surface is at least one of:
an enzyme, and/or
a substrate for enzymatic reactions, and/or
an antibody, and/or
an antigen, and/or
an aptamer, and/or
an ELISA assay, and/or
redox reaction reagents, and/or
polymeric membranes made using polymer and plasticizer, and/or
nanoparticles, such as liposomes and transferosomes, and/or
buffers and dyes for chemical reactions.

Multiple reagent chemistries and biological assays may be immobilized in the reaction chambers and detection chambers.

An ELISA assay is an enzyme-linked immunosorbent assay. Aptamer-aptamer and aptamer-antibody reagents are suitable for on-site diagnosis. In the case of an aptamer-antibody reagent, the aptamer is immobilized, and a secondary antibody is functionalized with signalling moieties which bind to the captured target for generating specific signals. The format of the assay may be direct, competitive or non-competitive sandwich assays.

The reagents and biological assays may be immobilized by methods such as chemical crosslinking, sol-gel-embedded, microbeads-immobilization either magnetic or agarose based, nanoparticles, optical polymer films or membranes and physical adsorption, or the like.

In a further embodiment, the reagent dispensed onto a reaction chamber surface is at least one of a micro-probe or a bioreceptor.

Reagents may be dry coated and embedded on one or more layers in the microfluidic chip such that during use of the microfluidic chip, fluid directed through fluidic channels to the desired layer containing the dry coated reagent, solubilizes the dry reagents thereby creating a liquid reagent in a reaction chamber or detection chamber.

In another embodiment, at least one of the reagents is targeted at reacting with one of: saliva, semen, cervical mucus, blood serum, blood plasma, urine, sweat, a soil extract.

In an embodiment, the fluid sample may be or comprise water, saliva, semen, cervical mucus, blood including serum and plasma, urine, sweat, agricultural and environmental extracts, both organic and inorganic.

In some embodiments of the invention, providing a layer with one or more fluidic channels further comprises providing a zig-zag shape to a part of or the whole of one or more of the fluidic channels.

In some embodiments of the invention, the method further comprises engraving a part of or the whole of at least one surface of one or more of the fluidic channels, the engraving comprising one or more lines in the direction of the fluid flow or one or more lines in a direction being at an angle to the direction of the fluid flow.

In another embodiment of the invention, the method further comprises engraving a part of or the whole of at least one surface of one or more of the fluidic channels with a pattern.

In some embodiments of the invention, the method further comprises modifying at least one of the reaction chamber surfaces and/or detection chamber surfaces by at least one of the processes of:
laser patterning, and/or
chemical treatment, such as e.g. coating, immersion in a solvent, incubation in a solvent, and/or
exposure to UV radiation.

The invention further relates to a microfluidic chip, wherein the microfluidic chip is obtained using the method according to the second aspect.

The considerations relating to the flow of the fluid sample through the detection chamber of the microfluidic chip of the first aspect of the invention are also applicable to the flow of the fluid sample through any optional reaction chamber. The functional purpose of the detection chamber and reaction chamber are however different. Primarily, the detection chamber requires an even coating of the fluid sample to ensure that at least qualitative and typically quantitative analysis of the contents of the sample may be performed.

In contrast, the reaction chamber contains reagents that interact and react with the fluid sample prior to it being analysed in the detection chamber. Such interactions or reactions may require a certain contact time between the fluid sample and the reaction chamber, and/or a certain residence time between the reaction chamber and the detection chamber to ensure that the relevant interaction/reaction has completed. There is therefore a need for microfluidic devices powered by capillary flow that allow for complex reactions of the test fluid without compromising device usability.

In a third aspect, the invention relates to a microfluidic chip comprising:
an inlet;
at least one fluid path comprising at least one fluidic channel from the inlet to a detection chamber, said at least one fluid path comprising a reaction chamber between the inlet and the detection chamber;
characterised in that
the reaction chamber is shaped with an aspect ratio of 3:2 or higher.

The “aspect ratio” of the reaction chamber is defined as the ratio of the length of the chamber to the width of the chamber. A higher aspect ratio has a smaller width as compared to length.

As used herein, the “width” of a chamber (e.g. a reaction chamber) corresponds to the largest dimension of the chamber which is orthogonal to the direction of idealised capillary flow.

As used herein, the “length” of a chamber (e.g. a reaction chamber) corresponds to the dimension of the chamber in the direction of idealised capillary flow.

Accordingly, the “depth” of a chamber (e.g. a reaction chamber) corresponds to the dimension of the chamber which is orthogonal to both the direction of idealised capillary flow and the width in an enclosed fluidic path.

Typically, the depth of any fluidic path, including a chamber in the path such as a reaction chamber, is small, to ensure that the capillary force moving the fluid sample is maintained. The microfluidic chip can therefore be viewed as a pseudo-two dimensional device, with the width being the dimension orthogonal to the idealised capillary flow, and the length being the dimension in line with the capillary flow.

In an enclosed fluid path, the depth of the reaction chamber (excluding any surface features such as grooves) desirably does not vary along the length of the chamber.

The transitional zone between the fluidic channel and reaction chamber is desirably filleted. Typically, the transitional zone between the reaction chamber and outlet is also filleted.

Suitable dimensions for the filleted portions of the reaction chamber are identical to those described above in relation to the detection chamber.

The reaction chamber typically has a line of symmetry running along its length. A particularly suitable shape for the reaction chamber is oval.

The use of an oval shaped reaction chamber has been found to provide an excellent balance of exposure of the fluid sample to the reagents in the reaction chamber and transition time of the fluid sample through the reaction chamber as it moves by capillary flow.

In particular, investigations have found that a reaction chamber with an oval shape having an aspect ratio of 3:2 or higher provide the desired level of contact with the reagents in the reaction chamber without impacting the flow rate through the chamber, thereby improving device performance.

As the fluid sample moves through the reaction chamber, the rate of flow by capillary action slows as the cross-sectional area of the chamber increases. Rapidly increasing the chamber width will greatly reduce the rate of movement of the fluid sample along the fluidic path, creating a deadzone where the capillary flow is stalled. Using an oval reaction chamber with the specified aspect ratio ensures that the speed of capillary flow remains high.

Typically, controlling the length of the reaction chamber to be from 3 mm to 12 mm will give an optimum reconstitution time, for instance from 4 mm to 10 mm.

With this range of lengths, the width of the reaction chamber is typically from 2 to 8 mm, more typically from 2 to 5 mm.

If a larger reaction chamber is required, it is desirable to increase the length of the chamber to increase the aspect ratio, thereby not significantly impacting the rate of flow through the chamber. The aspect ratio can therefore be 2:1 or higher, or 3:1 or higher.

Thus, the typical dimensions of the reaction chamber are a width of from 2 mm to 8 mm and an aspect ratio of 3:2 or higher.

More desirably, the reaction chamber has a width of from 2 mm to 5 mm, and an aspect ratio of 2:1 or higher.

The microfluidic chip of the third aspect can be formed from any material and/or structure allowing capillary flow. Suitable materials that allow capillary flow include wicking materials such as paper or card.

The fluid path in the microfluidic chip of the third aspect may also be an enclosed channel, in which embodiments the chip may be made from similar materials as the first aspect, and/or made by a method of the second aspect. Likewise, the depth of the fluidic channel is typically the same as specified above for the first and second aspects. The depth of the reaction chamber is also typically in line with the depth of the detection chamber set out above.

Thus, the depth of the reaction chamber (i.e. the largest dimension to the extreme of any surface feature such as a groove) is typically at least 500 μm, e.g. from 500 to 1500 μm, more typically from 500 to 1200 μm, such as from 800 to 1000 μm.

The reaction chamber is therefore typically deeper than the fluidic channel. The transition from the fluidic channel to the reaction chamber will typically be stepwise. Surprisingly, this does not affect the wicking provided the width/length profile of the reaction chamber are in line with the third aspect, and particularly when the transition between the fluidic path and the reaction chamber is filleted. The change in width profile controls the wicking despite the step change in the depth.

The depth of the reaction chamber can be used to control the flow rate and hence the residence time of the fluidic sample in the reaction chamber. A deeper chamber will result in a much slower flow rate, and a longer residence time.

The floor of the reaction chamber, that is the surface defined by the width and length of the chamber, may have surface features such as grooves. Such surface features increase the surface area of the reaction chamber, allowing a greater amount of reagent to be disposed on the surface.

Desirably, the grooves may be oriented orthogonal to the flow direction. In such embodiments, the grooves can influence the speed of the fluid sample as it moves through the chamber, slowing down the rate of capillary flow and increasing the residence time in the reaction chamber.

When orthogonal to the capillary flow, two adjacent grooves are typically equidistant to ensure a smooth capillary flow. When straight, the adjacent equidistant grooves therefore are parallel. However, the grooves need not necessarily be straight across the entire width of the reaction chamber. Due to the meniscus formed as the fluid sample meets the chamber wall, the front of the capillary flow may be curved near the chamber walls to match the profile of the fluid sample more closely as it flows through the chamber.

In practice however, parallel grooves are typically used which are orthogonal to the flow direction at the centre of the reaction chamber.

A suitable way to form the grooves (or other surface features) is by laser etching.

Typical dimensions for the grooves, and particularly those formed by laser etching, are a depth of from 20 to 200 μm, e.g. from 30 to 150 μm such as from 50 to 100 μm.

Typical widths of the grooves are from 10 to 150 μm, e.g. from 10 to 100 μm, ideally from 10 to 60 μm.

The distance between the grooves can vary. The shorter this distance, the more grooves can be fitted into a given space. However, the functional role of the grooves is to increase the surface area of the reaction chamber, and (depending on their orientation) to control the speed of flow through the chamber and hence the residence time of the fluid sample in the chamber. The distance between the grooves will therefore depend on the required balance to ensure the desired residence time and amount of reagent that is required to interact with the fluid sample.

Nevertheless, the distance between the grooves is desirably at least 20 μm, with typical distances being from 20 to 150 μm, e.g. from 20 to 100 μm, ideally from 30 to 80 μm.

When constructed with these dimensions, the grooves allow for an optimum balance of increase in surface area, increased in binding affinity of a reagent dispensed thereon, and (when suitably oriented) control of the capillary flow.

Although described with reference to the reaction chamber, the grooves may also be present in the detection chamber. Including grooves in the detection chamber can allow a much higher surface area to facilitate the inclusion of the detection reagent. Likewise, it can allow for control of flow through the detection chamber, to ensure that the fluid sample comes into contact with suitable amounts of the detection chamber to allow the detection reaction to take place.

Similarly, grooves may be included on other parts of the fluid channel, to allow control of the flow of the fluid sample as it moves through the microfluidic chip.

In a fourth aspect, the invention relates to a microfluidic system comprising:
a microfluidic chip according to the first or third aspect (or obtained using the method according to the second aspect),
an analysis device, the analysis device comprising:
   a barcode scanner,
   a microfluidic chip inlet, where the microfluidic chip inlet is suitable for insertion of the microfluidic chip into the analysis device,
   an optical sensor,
   a lens array,
   one or more light sources,
   an optical filter,
   a display screen,
   a power supplying element.

In another embodiment, the microfluidic system further comprises a pre-processing device for providing the fluid sample based on a sample to be examined. The pre-processing may comprise at least one of:
removing a fraction of the sample to be examined by filtering,
mixing the sample to be examined with a reagent, and/or
dissolving at least a part of the sample to be examined using an appropriate solvent.

In a fifth aspect, the invention relates to a method for analysing a fluid sample, comprising:
providing a microfluidic chip in accordance with the first or third aspect (or obtained using the method according to the second aspect),
providing the fluid sample at the inlet of the microfluidic chip,
measuring, subsequent to providing the fluid sample at the inlet, electromagnetic radiation emitted from one or more of the detection chamber surfaces.

In a further embodiment, the method for analysing a fluid sample further comprises performing the measuring at multiple points in time.

In another embodiment, the method for analysing a fluid sample further comprises measuring electromagnetic radiation having wavelengths in the interval 350 nm to 1000 nm or 400 nm to 700 nm emitted from one or more of the detection chamber surfaces.

It has been found that the flow rate of the fluid sample through the microfluidic chip can be controlled by adding a non-ionic surfactant to the fluid sample prior to placement on the chip.

Non-ionic surfactants that can be used include fatty acid ethoxylates, ethoxylated amines, fatty acid amides, fatty acid esters of sugar alcohols, fatty acid esters of sugars, fatty alcohol derivatives of sugars, amine oxides, sulfoxides, and phosphine oxides.

Particular non-ionic surfactants include fatty acid esters of sugar alcohols, such as fatty acid esters of a sugar alcohol selected from glycerol, erythritol, threitol, arabitol, xylitol, ribitol, mannitol, sorbitol, galactitol, fucitol, iditol, inositol, volemitol, isomalt, maltitol, lactitol, or ethoxylated derivatives thereof.

Suitable ethoxylated derivatives of the dehydrated sugar alcohol typically contain from 2 to 40 ethoxy units, for instance 4 to 30 ethoxy units or 15 to 25 ethoxy units.

Desirable sugar alcohols are selected from xylitol, mannitol, sorbitol, or ethoxylated derivatives thereof, with sorbitol or ethoxylated derivatives thereof being commonly used.

By “sugar alcohol” is meant a polyhydric organic compound derived from a sugar, including cyclised dehydrated derivatives thereof such as sorbitan.

Desirably, the non-ionic surfactant is a polysorbate (i.e. ethoxylated sorbitan esterified with a fatty acid), with particular polysorbates including polysorbate 20, polysorbate 40, polysorbate 60 and polysorbate 80. Polysorbate 20, sold under the trade name Tween20, has been found to be particularly useful.

Suitably the fluid sample includes from 0.2 to 3 wt % non-ionic surfactant (e.g. polysorbate), typically from 0.3 to 2.5 wt %, desirably from 0.5 to 1.5 wt %.

As the amount of non-ionic surfactant in the fluid sample is increased, the speed of capillary flow through the microfluidic chip is increased.

The invention therefore further relates to the use of a non-ionic surfactant (particularly a polysorbate) to increase the rate of capillary flow in a microfluidic chip.

The first, second, third, fourth and fifth aspect of the present invention may each be combined with any of the other aspects as long as the combination makes sense. These and other aspects of the invention will be apparent from and elucidated with reference to the embodiments described hereinafter.

### BRIEF DESCRIPTION OF THE FIGURES

The invention will now be described in more detail with regard to the accompanying figures. The figures show one way of implementing the present invention and is not to be construed as being limiting to other possible embodiments falling within the scope of the attached claim set.

FIG. 1 shows schematically a plurality of layers used in the fabrication of a microfluidic chip according to an embodiment of the present invention.

FIG. 2 shows a side view of the plurality of layers from FIG. 1.

FIG. 3 shows a schematic illustration of a microfluidic chip according to an embodiment of the present invention. The illustration shows features, which would not necessarily be visible to the naked eye after fabrication of the microfluidic chip.

FIG. 4 shows a schematic illustration of a microfluidic chip according to an embodiment of the present invention. The illustration shows features, which would not necessarily be visible to the naked eye after fabrication of the microfluidic chip.

FIG. 5 shows a closer view of parts of the microfluidic chip in FIG. 4.

FIG. 6A and 6B each show schematically an example of a plurality of layers used in embodiments of the present invention to fabricate a microfluidic chip. FIG. 6A shows three layers, while FIG. 6B shows four layers.

FIG. 7 shows schematically a side view of an analysis device.

FIG. 8 shows schematically a syringe for use in providing a fluid sample to the inlet of a microfluidic chip.

FIG. 9 is a flow-chart of a method according to the invention.

FIG. 10 is a flow-chart of a method according to the invention.

### DETAILED DESCRIPTION OF EMBODIMENTS

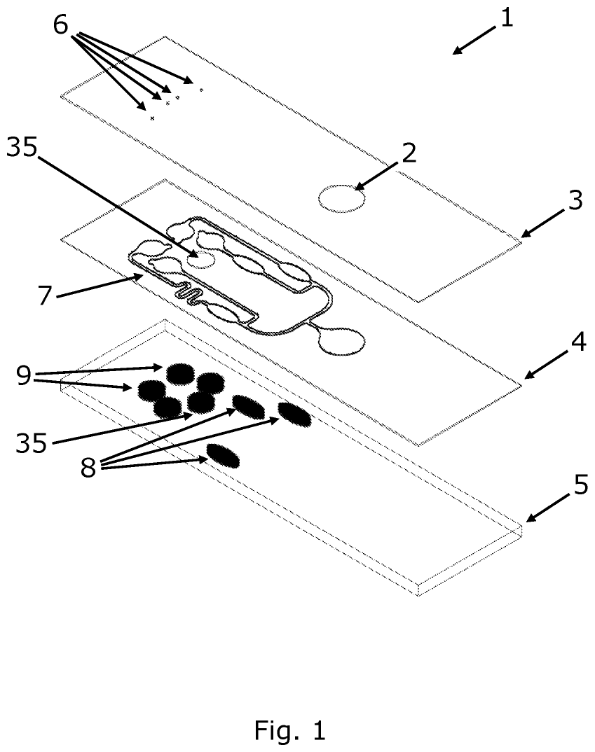

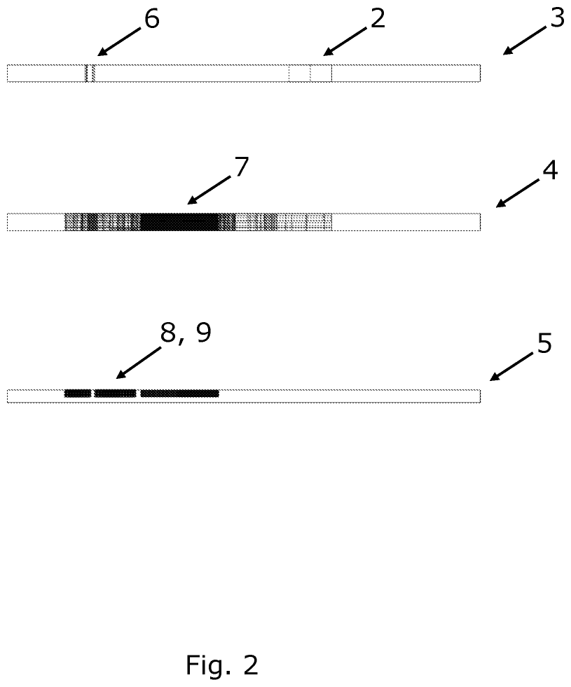

FIG. 1 and FIG. 2 show schematically a plurality of layers 3, 4, 5 used in the method of fabrication of a microfluidic chip 1 according to an embodiment of the present invention. Each of the layers in the plurality of layers 3, 4, 5 is substantially shaped as a rectangular cuboid having two opposite surfaces, which are significantly larger than other surfaces of the layer.

A base layer 5 made of a polymeric material is provided. The base layer may be made of a material and/or have a finish, which makes it easier for a user to handle the microfluidic chip. One or more detection chamber surfaces 9 and, optionally, one or more reaction chamber surfaces 8 are provided by making an indentation and/or pattern in the base layer 5. The indentation and/or pattern may be made by laser engraving. Advantageously, the base layer 5 may be made of PMMA acrylic, which functions both as a stable support for a user when holding the chip and as an inert medium on which to dispense one or more reagents onto.

The reaction chamber surface(s) 8, if present, and/or the at least one detection chamber surface 9 is prepared by:
dispensing at least one reagent onto the reaction chamber surface 8 and/or detection chamber surface 9,
subsequently, if required to immobilize the dispensed reagent, drying and/or ventilating the reaction chamber surface 8 and/or detection chamber surface 9.

In some embodiments, only the detection chamber surface comprises at least one reagent, while in other embodiments one or more reaction chamber surfaces located upstream from the detection chamber will also comprise at least one reagent.

In the embodiment in FIG. 1, the base layer therefore also functions as a reagent carrier layer, i.e. a layer on which at least one reagent is dispensed. In another embodiment, the reagent carrier layer is not the base layer.

In FIG. 1, a fluidic channel layer 4 made of a polymeric material is provided. A possible choice for the polymeric material is a composite sandwich material having PET or PMMA in the middle being sandwiched by an acrylic adhesive on both sides. This allows for a thin layer, while providing rigidity and integrity of the fluidic channel(s).

The fluidic channel layer 4 comprises one or more fluidic channels 7, which function to transport fluid through the microfluidic chip 1. The one or more fluidic channel(s) 7 are provided as a combination of:
engraving a channel structure onto a larger surface of the fluidic channel layer 4, and/or
cutting throughgoing channels in the larger surfaces of the layer, and/or
cutting one or more fluidic passage holes as a throughgoing hole cut in the larger surfaces of the layer.

A fluidic passage hole is thus a fluidic channel that allows fluid to flow from one layer to another.

It is also possible for the reagent carrier layer and fluidic channel layer to be the same layer.

In FIG. 1, a capping layer 3 made of a polymeric material is provided. An inlet 2 and one or more outlets 6 is provided in the capping layer. The outlets may be of any suitable shape and size and act as vents, which enables capillarity.

In other possible designs, the inlet 2 is provided in the base layer, a reagent carrier layer or a fluidic channel layer.

Subsequent to preparation of the reaction chamber surface(s), if present, and detection chamber surface(s), the plurality of layers 3, 4, 5 is assembled by stacking the layers in the plurality of layers 3, 4, 5 on top of each other with a larger surface of one layer aligning with a larger surface of another layer. In the embodiment shown in FIG. 1, the fluidic channel layer could advantageously be made of a composite sandwich material as described above.

The one or more outlets 6 align with the one or more detection chamber surface(s) 9 in the reagent carrier layer as well as with any cut-through in intermediate layers necessary to ensure that any electromagnetic radiation emitted from a detection chamber surface 9 can leave the microfluidic chip 1. The electromagnetic radiation typically leaves through an inspection window, with the outlets and outlet vents desirably being positioned away from the detection chamber surfaces.

At least one fluid path is provided as the inlet 2, fluidic channel(s) 7, reaction chamber surface(s) 8, if present, detection chamber surface(s) 9 and outlet(s) 6 are aligned. When the layers of the plurality of layers 3, 4, 5 are assembled and bonded the at least one fluid path is formed as the fluidic channel(s) 7 are sealed by the adjacent layer(s). Likewise, as the detection chamber surface(s) 9 are partly enclosed by adjacent layers, detection chamber(s) are formed in such a way that fluid may enter and exit the detection chamber(s). Equally, any reaction chamber surface(s) 8 are partly enclosed by adjacent layers, creating reaction chamber(s) in such a way that fluid may enter and exit the reaction chamber(s).

This provides at least one fluid path extending from the inlet 2, through at least one fluidic channel 7, optionally past at least one reaction chamber upstream from any detection chamber, to one of the at least one detection chambers and to an outlet 6. The at least one fluid path will allow a fluid sample dispensed onto the inlet 2 to move through fluidic channel(s) 7 to at least one detection chamber 9 due to capillary motion.

In the embodiment shown in FIG. 1, where the fluidic channel layer 4 advantageously may be made of a composite sandwich material with adhesive on both of the larger surfaces, bonding is done by heating of the assembled plurality of layers. The heating may be done by using a lamination device on low heat.

In other designs, bonding of the layers in the plurality of layers 3, 4, 5 may be achieved by e.g. ultrasonic welding, chemical welding, adhesive material coating or other intrinsic material properties.

In some designs, the capping layer further comprises an identifier. The identifier may be an engraving in the capping layer.

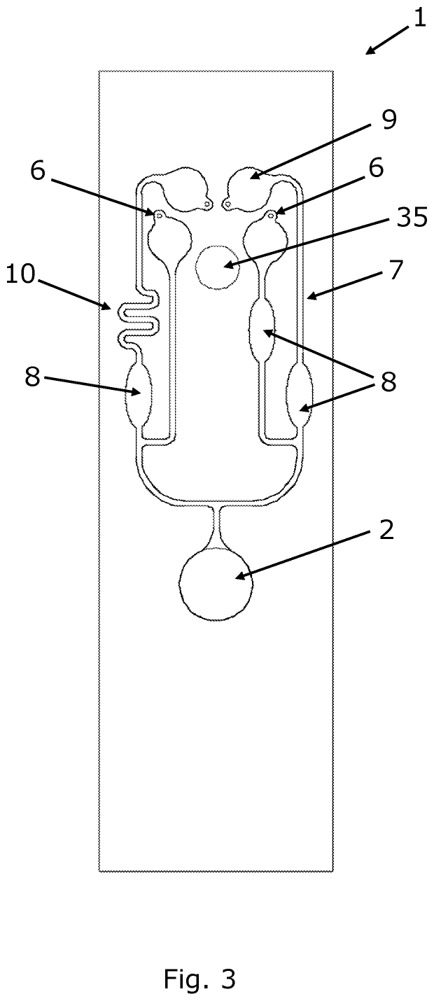

In FIG. 1 is shown a chamber 35, which is not connected to the fluidic path. This is a chamber, which is unused in the embodiment shown in FIG. 1, but which may be connected to the fluidic path in another embodiment to provide a further reaction or detection chamber. The unused chamber 35 is also shown in FIGS. 3, 4 and 5.

FIG. 3 shows a schematic illustration of a microfluidic chip 1 according to an embodiment of the present invention. The illustration shows features, which would not necessarily be visible to the naked eye after fabrication of the microfluidic chip 1. In FIG. 3, fluidic channels, reaction chambers, detection chambers as well as inlet 2 and outlets 6 can be seen.

The fluidic channel(s) 7 are suitable for carrying at least a part of the fluid sample and each fluidic channel 7 is in fluid connection with an outlet 6 downstream from the inlet 2 thus allowing the received fluid sample to flow from the inlet 2 towards the outlet 6 of each fluidic channel. Each of the fluidic channel(s) 7 thus have a common inlet 2 for the fluid sample. A fluidic channel may be:
straight,
meandering, e.g. in a zig-zag shape 10, which facilitates mixing of the fluid sample, or
intersecting, i.e. joining or splitting away from a fluid path from inlet 2 to outlet 6
a shape to facilitate a desired property of the fluidic channel.

By designing the fluidic components, i.e. the parts of the microfluidic chip 1, which come in contact with the fluid sample, such as e.g. inlet 2, outlet(s) 6, fluidic channels 7, chamber surfaces 8, 9, etc., to promote fluidic action, a microfluidic chip 1 will have a fluid flow that is solely powerless flow. By powerless is meant that no external power such as from a pump is necessary to cause the flow of the fluid sample in the microfluidic chip 1. The fluid sample may flow through the microfluidic chip 1 due to capillary flow, gravitational flow, air pressure, and the like.

In some embodiments, each reaction chamber may comprise at least one channel-specific reagent, i.e. a reagent for that part of the fluidic channel(s) and each detection chamber may comprise at least one detection chamber reagent. Such a detection chamber reagent may be imbedded or immobilized or loaded within the detection chamber. The detection chamber reagent may be selected to meet a specific need by consisting of a set of analyte-responsive elements, which will provide electromagnetic radiation, when the analyte is present in the fluid that reaches the detection chamber. Thus, a detection chamber reagent, but also a channel-specific reagent, may become activated if one or more analytes are present in the fluid sample. The activation will ideally result in electromagnetic radiation being emitted from the microfluidic chip 1 as a result of a reaction between the channel-specific reagent and/or a detection chamber reagent with the one or more analytes, if present.

In some embodiments, a channel-specific reagent is at least one of a micro-probe or a bioreceptor.

When a fluid sample is put into the inlet 2 of the microfluidic chip 1, the fluid flows through the fluidic channels 7 and any reaction chambers to reach the at least one detection chambers and here provide a detectable signal if the channel-specific reagent became activated. A reaction in a reaction chamber may cause electromagnetic radiation to be emitted, but ideally, the reaction chambers are where reagents, such as e.g. recognition molecules or reaction species, are located. Often these reagents only form intermediate products, while the one or more detection chambers are where dyes, enzymes, etc. react with the fluid sample to give off an electromagnetic signal for detection. The electromagnetic signal produced may be characterised as being either colorimetric or fluorimetric. A specific signal will usually be produced within a pre-determined time period. For example, a Nitrogen test signal is produced within a time period of 50 seconds, while a Potassium test produces an electromagnetic signal within 36 seconds.

In some embodiments, the microfluidic chip 1 comprises a plurality of reaction chambers. A microfluidic chip 1 may comprise several reaction chambers, possibly as many as twenty reaction chambers.

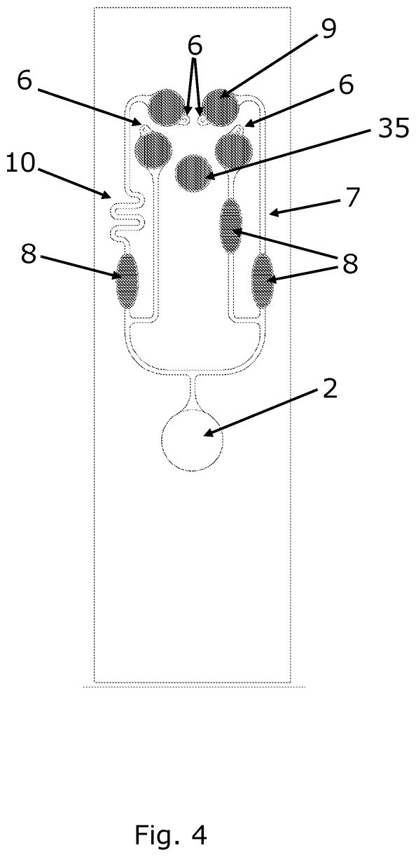

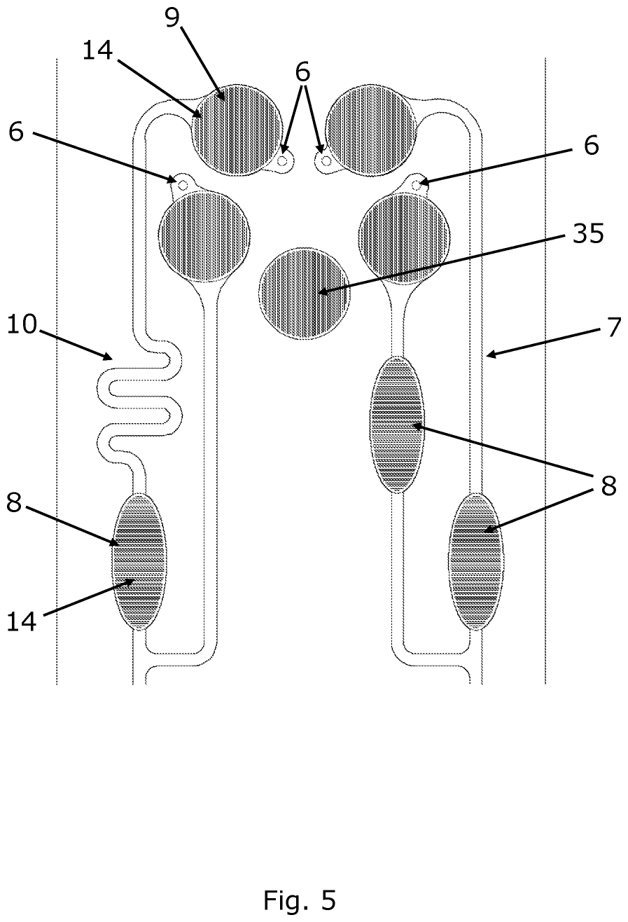

FIGS. 4 and 5 show a schematic illustration of a microfluidic chip 1 according to an embodiment of the present invention. The illustration shows features, which would not necessarily be visible to the naked eye after fabrication of the microfluidic chip. In FIG. 4 is shown an embodiment in which reaction chamber surfaces 8 and detection chamber surfaces 9 have been engraved with lines. The lines may be engraved with a laser. Such an engraved surface 14 along the fluid path through the microfluidic chip 1 may be used to manipulate the flow of the fluid, for instance, if the fluid has to react with a chemical in a slow manner.

A reaction chamber surface 8 and/or a detection chamber surface 9 may be modified by at least one of the processes of:
laser patterning,
chemical treatment, such as e.g. coating, immersion in a solvent, incubation in a solvent, and/or
exposure to UV radiation.

By modifying a reaction chamber surface or detection chamber surface the affinity of the surface to accept binding of molecules may be increased. For example, a pattern created with e.g. a laser may allow for easier physical adsorption of molecules in the drying process. In an embodiment, at least one of the patterns engraved to provide a reaction chamber surface and/or a detection chamber surface increases the binding affinity for a reagent to be dispensed thereupon.

Engraving of a surface anywhere along the fluid path may be used to alter the fluid flow in that part of the fluid path. This is not shown in FIGS. 4 and 5, but will be similar to the method used for the reaction chamber surface(s) and detection chamber surface(s).

Thus, a part of or the whole of one or more of the fluidic channels may be engraved, e.g. by a laser, the engraving comprising a pattern and/or one or more lines in the direction of the fluid flow or one or more lines in a direction being at an angle to the direction of the fluid flow. When the one or more engraved lines are in the direction of the fluid flow, they may facilitate the flow of the fluid inside that part of the fluidic channel. When the one or more engraved lines are in a direction at an angle to the direction of the fluid flow the engraved lines may slow down the fluid as the fluid flows past the engraved part of the fluidic channel. Usually, the closer the angle between the lines and the direction of the fluid flow is to 90 degrees, i.e. the closer the lines are to being orthogonal to the direction of the fluid flow, the more the fluid flow will be slowed down.

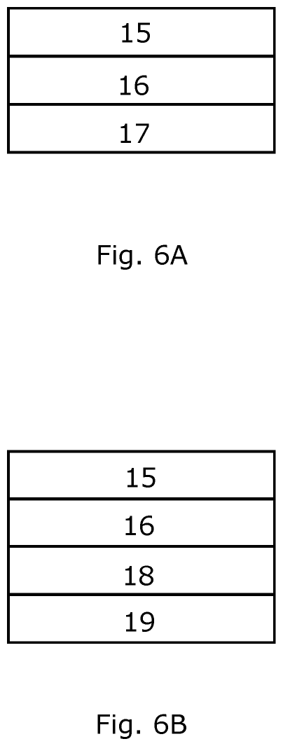

FIG. 6A and 6B each show schematically an example of a plurality of layers used in embodiments of the present invention to fabricate a microfluidic chip. FIG. 6A shows three layers, which may be: a base layer 17, which also functions as reagent carrier layer, a fluidic channel layer 16 and a top layer 15. FIG. 6B shows four layers, which may be: a base layer 19, a reagent carrier layer 18, a fluidic channel layer 16 and a top layer 15.

If surface engraving of the base layer 17 and/or reagent carrier layer 18 would cause the release of reactive species from within the polymeric material, reaction and detection chambers may be formed by cutting or engraving structures in layers, which go on top of the base layer 17 and/or reagent carrier layer 18. A possibility is to cut a fluidic passage hole in a larger surface of at least one layer of the plurality of layers, whereby the fluidic passage hole cut-out will define a chamber surface on an adjacent layer after assembly of the plurality of layers.

In further embodiments, the microfluidic chip 1 may have fewer than three layers or more than four layers.

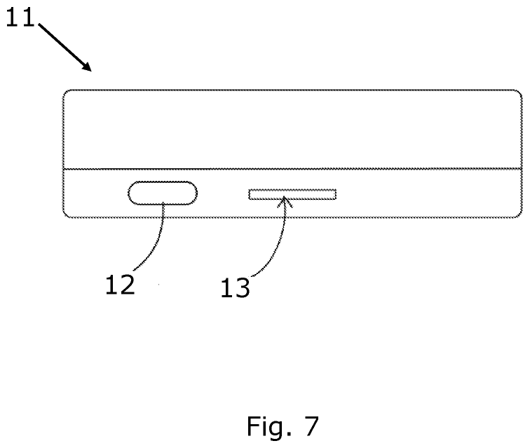

FIG. 7 shows schematically a side view of an analysis device 11. Visible in FIG. 7 is a barcode scanner 12 and a microfluidic chip inlet 13. The analysis device 11 may be used for analysing any electromagnetic radiation emitted from one or more detection chambers in a microfluidic chip 1. Such an analysis device will comprise:
a barcode scanner 12,
a microfluidic chip inlet 13, where the microfluidic chip inlet 13 is suitable for insertion of a microfluidic chip 1 into the analysis device 11,
an optical sensor,
a lens array,
one or more light sources,
an optical filter,
a display screen,
a power supplying element.

The barcode scanner 12 allows for information about a microfluidic chip 1 to be communicated to the analysis device 11 by scanning an identifier located on the microfluidic chip 1. The identifier may be an engraving on the microfluidic chip. The information communicated to the analysis device 11 by scanning of an identifier may comprise type of chip and what analytes the chip is suitable for detecting, which enables the analysis device 11 to recognize the field of analysis and therefore run a suitable specific algorithm for the analysis.

A microfluidic chip inlet 13 provides a suitable inlet for insertion of a microfluidic chip 1 into the analysis device 11. The size of the microfluidic chip inlet 13 and the fixture that aligns the microfluidic chip 1 with the optical sensor inside the analysis device 11 may be of varying shapes and sizes to allow for differently shaped microfluidic chips 1 to be inserted into the analysis system 11.

An optical sensor, such as a CMOS sensor, may be positioned in combination with a lens array and placed on a mechanical fixture that aligns it with the one or more detection chambers in the microfluidic chip 1 for correct signal transfer of electromagnetic radiation from the microfluidic chip 1 to the analysis device 11.

The microfluidic system may be suited for a specific type of analysis, whereby the microfluidic chip 1 will comprise a suitable set of channel-specific reagents and/or a suitable set of detection chamber reagents and the analysis device 11 will comprise a suitable set of components for the specific type of analysis.

One or more light sources may provide illumination, if necessary, for an optical sensor viewing the one or more detection chambers of the microfluidic chip 1. The appropriate use of one or more illumination sources depends on the chemical reaction produced and may be used to create contrast. For example:
if the chemistry produces a pink, red or maroon colour, then a green LED can be used to create contrast,
if blue colours are produced, a red LED can be used, while
if fluorescence is produced, a UV LED can be used.

An optical filter blocks specific wavelengths of light from entering the optical sensor thereby filtering unwanted signals that may arise during analysis. One example of an applicable filter for an analysis device is an IR filter that blocks infrared light from entering the optical sensor.

The display screen may comprise be any suitable display technology, such as a capacitive LCD touch screen.

The analysis device 11 may function similar to many multichannel detector systems such as CCD, CMOS, photodiode, photomultiplier tubes and the like. The arrangement of light source(s) and detector(s) is fixed by a mechanical fixture, while the operational sequence of lighting and detection can be varied based on the application or use. Similarly, it is possible to combine more than one light sources or detectors to monitor different types of responses on sensor films, and then combine them in manners known in the prior art.

In some embodiments, the light sources are red (650 nm), green (600 nm), blue (420 nm) and UV (380 nm) intensities and the value of each pixel seen by the optical sensor is recorded in a digital file. The digital file may undergo transformations and processing to convert data into a usable form and combine with empirical data to produce a defined output. The analysis device 11 may use multiple LEDs of varying spectrums to irradiate the subject for the pixel intensity measurements. Colour response and grey scale response may be recorded in pixel points by the optical sensor. Any change in colour/fluorescence or change in intensity of colour/fluorescence of each pixel of the image taken of the at least one detection chamber is used to convert light data to concentration of the analyte.

The overall flow of signal processing of the analysis device may follow the sequence of: signal capture, signal manipulation, signal to data interpretation, data transformation, data comparison, result derivation and result display. The entirety of the flow may be completed on the analysis device itself or may be completed on separate processing units where the data at any stage may be uploaded via internet to processing units housed elsewhere.

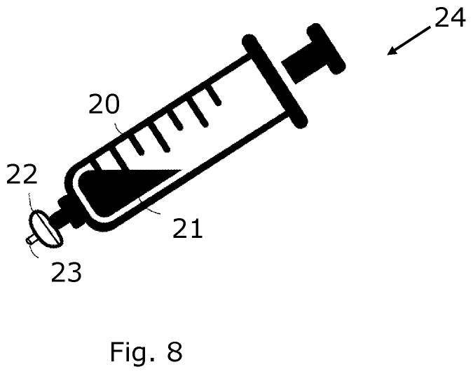

FIG. 8 shows schematically a syringe 24 for use in providing a fluid sample 21 to the inlet 2 of a microfluidic chip 1. Such a syringe 24 may be used to pre-process the fluid sample 21, where the pre-processing may comprise mixing or dissolving of one or more reagents or other chemical additions, all of which is conducted in the column 20 of the syringe 24. A filter 22 may be added onto the syringe 24 prior to or after the pre-processing of the fluid sample 21 being completed. For testing of the fluid sample 21 using a microfluidic chip 1, a droplet of fluid sample 21 is generated through the filter 22 and dispensed on the microfluidic chip 1 from the opening of the filter 23 to the inlet 2 of a microfluidic chip 1.

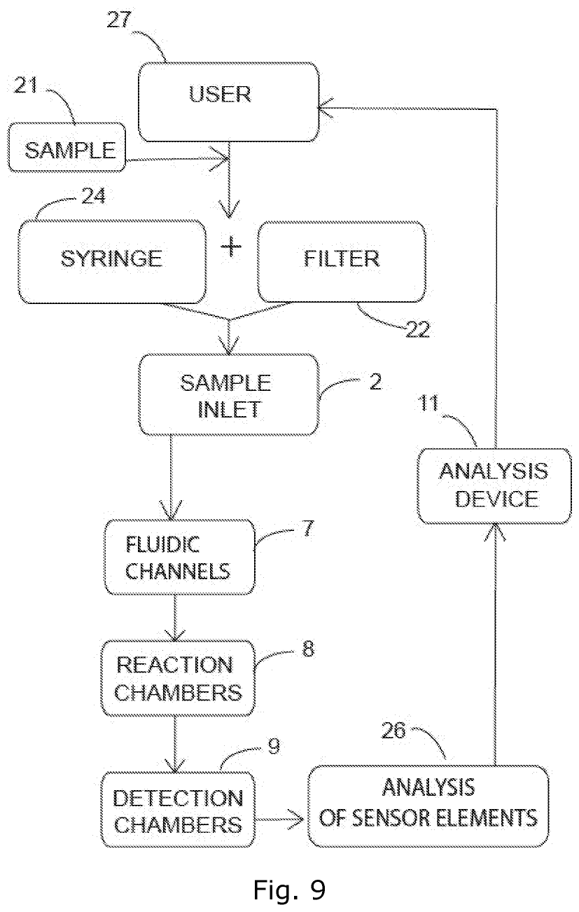

FIG. 9 is a flow-chart of a method according to the invention. The flow chart describes a method of using a microfluidic chip 1. In the method example depicted, the fluid sample 21, prior to being administered at the inlet 2, is treated with an extraction liquid 25 in a syringe 2 with filter 22. The extraction liquid used to dissolve the test sample 21 may contain chemicals that assist the flow of the fluid sample in the microfluidic chip 1. The fluid sample 21 flows into the fluidic channels 7, passing any reaction chamber surfaces 8, and further into the detection chambers to contact the detection chamber surface 9, where emission of any electromagnetic radiation caused by a reaction between an analyte and one or more reagents can leave the microfluidic chip 1. After analysis of any electromagnetic radiation 26 or lack thereof by the analysis device 11, information is passed on to a user 27.

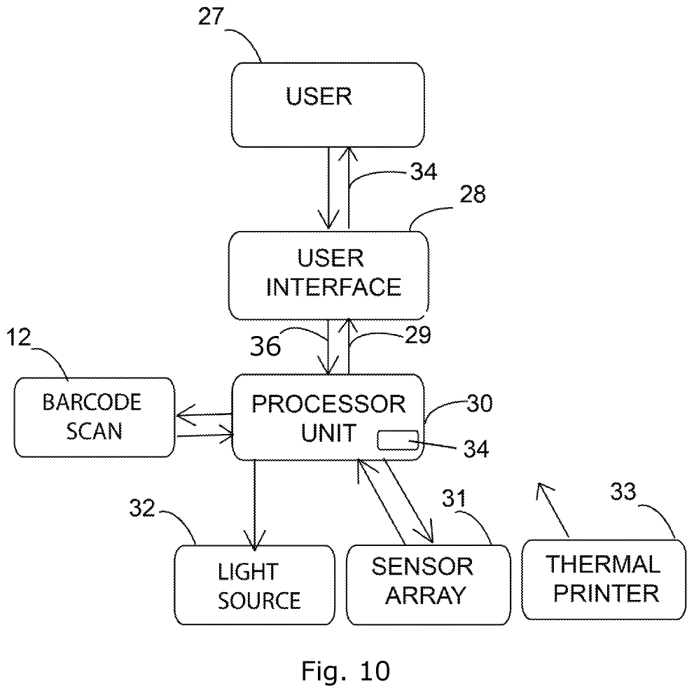

FIG. 10 is a flow-chart of a method according to the invention. The user interface 28 on the analysis device 11 can send input signals 36 to the processor unit 30, receive and display the output 29 from the processor unit 30. The processor unit 30 may have unidirectional or bidirectional communication with several elements including a sensor array 31, light source array 32, barcode scanner 12 and other peripheral devices such as a thermal printer 33. The communication of the processor unit 30 and the sensor array 31 and light source array 32 is the core functionality and may involve multiple passes of information to deliver a single result of the image data 34 to the user 27.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1 microfluidic chip

2 inlet

3, 4, 5 layers in a plurality of layers

6 outlet

7 fluidic channel

8 reaction chamber surface

9 detection chamber surface

10 zig-zag shaped fluidic channel

11 analysis device

12 barcode scanner

13 microfluidic chip inlet

14 engraved surface

15 top/capping layer

16 fluidic channel layer

17 bottom/base+reagent carrier layer

18 reagent carrier layer

19 bottom/base layer

20 column

21 fluid sample

22 filter

23 filter opening

24 syringe

25 extraction liquid

26 analysis of electromagnetic radiation

27 user

28 user interface

29 output

30 processor unit

31 sensor array

32 light source array

33 thermal printer

34 image data

35 unused chamber

36 input signals

1. A microfluidic chip comprising:
an inlet;
at least one fluid path comprising at least one fluidic channel from the inlet to an outlet, said at least one fluidic path comprising a detection chamber and optionally a reaction chamber between the inlet and the detection chamber;
said at least one fluidic path being enclosed and configured to allow a fluid sample dispensed onto the inlet to move through fluidic channels to at least one detection chamber surface due to capillary motion,
characterised in that
the outlet contains a vent to enable capillarity, said outlet being adjacent to the detection chamber and positioned substantially opposite to where the fluidic channel enters the detection chamber.

2. The microfluidic chip of claim 1, wherein the detection chamber surface is aligned with an inspection window, and wherein the outlet and vent does not overlap with the inspection window.

3. The microfluidic chip of claim 1 or claim 2, wherein the transitional zone between the fluidic channel and the detection chamber is filleted.

4. The microfluidic chip of claim 3, wherein the fillets have a curve with a radius of from 3 mm to 7 mm.

5. A microfluidic chip comprising:
an inlet;
at least one fluid path comprising at least one fluidic channel from the inlet to a detection chamber, said at least one fluid path comprising a reaction chamber between the inlet and the detection chamber;
characterised in that
the reaction chamber is shaped with an aspect ratio of 3:2 or higher.

6. The microfluidic chip according to claim 5, wherein the fluid path is enclosed, said reaction chamber having a depth of from 500 to 1500 μm, the floor of the reaction chamber contains grooves orthogonal to the flow direction, wherein the grooves have a width of from 10 to 150 μm, and a depth of from 20 to 200 μm.

7. The microfluidic chip according to claim 5 or claim 6, wherein the reaction chamber is shaped as an oval.

8. The microfluidic chip according to any of claims 5 to 7, wherein the width of the reaction chamber is from 2 to 5 mm.

9. The microfluidic chip according to any one of claims 5 to 8, wherein the aspect ratio of the reaction chamber is 2:1 or higher.

10. A method of fabricating a microfluidic chip (1), particularly a microfluidic chip according to any preceding claim, comprising at least one fluid path from an inlet (2), through at least one fluidic channel (7) and to an outlet (6), the method comprising:
providing a plurality of layers (3, 4, 5), which are initially separated, each of the layers in the plurality of layers (3, 4, 5) being made of at least one polymeric material, each of the plurality of layers (3, 4, 5) being substantially shaped as a rectangular cuboid having two opposite surfaces, which are significantly larger than other surfaces of the layer, wherein at least one layer of the plurality of layers (3, 4, 5) comprises an adhesive on both of its larger surfaces, ensuring that enough layers comprise an adhesive such that when the plurality of layers (3, 4, 5) are assembled at a later time at least one of any two larger surfaces facing each other comprises an adhesive,
providing the inlet (2) in one of the plurality of layers (3, 4, 5),
providing at least one outlet (6) in a larger surface of one of the plurality of layers (3, 4, 5),
providing at least one layer of the plurality of layers (3, 4, 5) with one or more fluidic channels (7), where providing a layer with fluidic channels (7) comprises at least one of:
engraving a channel structure onto one or both of the larger surfaces of the layer, and/or
cutting a channel structure by cutting throughgoing channels in the larger surfaces of the layer, and/or
cutting a fluidic passage hole by cutting a throughgoing hole in the larger surfaces of the layer thus creating a fluidic channel that allows fluid to flow from one layer to another,
optionally, creating at least one reaction chamber surface (8) by at least one of:
engraving on a larger surface of at least one layer of the plurality of layers (3, 4, 5) to make an indentation and/or a pattern, and/or
cutting a fluidic passage hole in a larger surface of at least one layer of the plurality of layers, whereby the fluidic passage hole cut-out will define a reaction chamber surface on an adjacent layer after assembly of the plurality of layers,
creating at least one detection chamber surface (9) by at least one of:
engraving on a larger surface of at least one layer of the plurality of layers (3, 4, 5) to make an indentation and/or a pattern, and/or
cutting a fluidic passage hole in a larger surface of at least one layer of the plurality of layers, whereby the fluidic passage hole cut-out will define a detection chamber surface on an adjacent layer after assembly of the plurality of layers,
preparing at least one of the reaction chamber surfaces (8), if present, and/or at least one of the detection chamber surfaces (9), wherein preparing a reaction chamber surface (8) and/or a detection chamber surface (9) comprises:
dispensing at least one reagent onto the reaction chamber surface (8) and/or detection chamber surface (9),
subsequently, if required to immobilize the dispensed reagent, drying and/or ventilating the reaction chamber surface (8) and/or detection chamber surface (9),
assembling the plurality of layers (3, 4, 5), where assembling the plurality of layers (3, 4, 5) comprises stacking the layers in the plurality of layers (3, 4, 5) on top of each other with a larger surface of one layer aligning with a larger surface of another layer, such that:
the inlet (2) is not covered,
at least one of any two larger surfaces facing each other comprises an adhesive,
at least one outlet (6) aligns with a detection chamber surface (9), the outlet (6) allowing electromagnetic radiation emitted from the detection chamber surface to leave the microfluidic chip (1),
the at least one fluid path is provided by aligning the inlet (2), fluidic channel(s) (7), reaction chamber surface(s) (8), if present, detection chamber surface(s) (9) and outlet(s) (6) such that the at least one fluid path further extends to one of the at least one detection chamber surfaces (9),
the at least one fluid path will allow a fluid sample dispensed onto the inlet (2) to move through fluidic channels (7) to at least one detection chamber surface (9) due to capillary motion, and
bonding the plurality of layers (4, 5, 6) together.

11. A method of fabricating a microfluidic chip according to claim 10, wherein the floor of the reaction and/or detection chamber contains grooves having a width of from 10 to 150 μm, and a depth of from 20 to 200 μm.

12. A method of fabricating a microfluidic chip according to claim 11, wherein the grooves are orthogonal to the flow direction.

13. A method of fabricating a microfluidic chip (1) according to any of claims 10 to claim 12, the method further comprising providing an identifier to the microfluidic chip (1), where the identifier is detectable by visual inspection or other types of inspection.

14. A method of fabricating a microfluidic chip (1) according to any of claims 10 to 13, wherein the adhesive is an acrylic adhesive.

15. A method of fabricating a microfluidic chip (1) according to any of claims 10 to 14, wherein the at least one layer comprising one or more fluidic channels (7) is made of polyethylene terephthalate (PET) or poly(methyl methacrylate) (PMMA).

16. A method of fabricating a microfluidic chip (1) according to any of claims 10 to 15, wherein each of the layers in the plurality of layers (3, 4, 5) provided are made of at least one of: a thermosetting polymer and/or a thermoplastic polymer and/or an elastomer and/or a glass and/or quartz.

17. A method of fabricating a microfluidic chip (1) according to any of claims 10 to 16, wherein a layer comprising at least one reaction chamber surface (8) and/or at least one detection chamber surface (9) is made of a different polymeric material than a layer comprising one or more fluidic channels (7).

18. A method of fabricating a microfluidic chip (1) according to any of claims 10 to 17, wherein at least one of the patterns engraved to provide a reaction chamber surface (8) and/or a detection chamber surface (9) increases the binding affinity for a reagent to be dispensed thereupon.

19. A method of fabricating a microfluidic chip (1) according to any of claims 10 to 18, wherein the inlet (2) is cut or engraved in a droplet shape, trapezoidal shape, triangular shape or any other tapering geometrical shape.

20. A method of fabricating a microfluidic chip (1) according to any of claims 10 to 19, wherein the at least one reagent dispensed onto a reaction chamber surface (8) and/or a detection chamber surface (9) is at least one of:
an enzyme, and/or
a substrate for enzymatic reactions, and/or
an antibody, and/or
an antigen, and/or
an aptamer, and/or
an ELISA assay, and/or
redox reaction reagents, and/or
polymeric membranes, such as ion-selective membranes made using polymer and plasticizer, and/or
nanoparticles, such as liposomes and transferosomes.

21. A method of fabricating a microfluidic chip (1) according to any of claims 10 to 19, wherein providing a layer with one or more fluidic channels (7) further comprises providing a zig-zag shape (10) to a part of or the whole of one or more of the fluidic channels (7).

22. A method of fabricating a microfluidic chip (1) according to any of claims 10 to 22, the method further comprising modifying at least one of the reaction chamber surfaces (8) and/or detection chamber surfaces (9) by at least one of the processes of:
laser patterning, and/or
chemical treatment, such as e.g. coating, immersion in a solvent, incubation in a solvent, and/or
exposure to UV radiation.

23. A microfluidic chip according to any of claims 1 to 9, as made by a method according to any of claims 10 to 22.

24. A microfluidic chip (1), wherein the microfluidic chip (1) is obtained using the method according to any one of claims 10 to 22.

25. A microfluidic system comprising:
a microfluidic chip (1) according to any of claim 1 to 9 or 24, or as obtained using the method according to any one of claims 10-22,
an analysis device (11), the analysis device (11) comprising:
a barcode scanner (12),
a microfluidic chip inlet (13), where the microfluidic chip inlet (13) is suitable for insertion of the microfluidic chip (1) into the analysis device (11),
an optical sensor,
a lens array,
one or more light sources,
an optical filter,
a display screen,
a power supplying element.

26. A method for analysing a fluid sample, comprising:
providing a microfluidic chip (1)) according to any of claim 1 to 9 or 24, or as obtained using the method according to any one of claims 10-22,
providing the fluid sample at the inlet (2) of the microfluidic chip (1),
measuring, subsequent to providing the fluid sample at the inlet (2), electromagnetic radiation emitted from one or more of the detection chamber surfaces. 27. A method as defined in claim 26, wherein the fluid sample contains 0.5 to 1.5 wt % polysorbate.

28. Use of a non-ionic surfactant, particularly a polysorbate, to increase the rate of capillary flow in a microfluidic chip.
